(19) United States
(12) Patent Application Publication
(10) Pub. No.: US 2024/0357971 A1
(43) Pub. Date: Oct. 31, 2024

(54) POLE SAW WITH LOW PROFILE

(71) Applicant: Milwaukee Electric Tool Corporation, Brookfield, WI (US)

(72) Inventors: Jordan Smith, Brookfield, WI (US); Alison Wilhelm, Brookfield, WI (US); John Whealon, Brookfield, WI (US)

(21) Appl. No.: 18/645,444

(22) Filed: Apr. 25, 2024

Related U.S. Application Data
(60) Provisional application No. 63/609,631, filed on Dec. 13, 2023.
(60) Provisional application No. 63/461,723, filed on Apr. 25, 2023.

(51) Int. Cl. A01G 3/08; B27B 17/00; B27B 17/02

(52) U.S. Cl. CPC A01G 3/086; B27B 17/0008; B27B 17/02

(57) ABSTRACT

A power tool is provided. The power tool includes a housing including an electric motor, a work element, and a drive shaft extending between the electric motor and the work element. The power tool is configured to fit within a cylinder having a diameter no greater than 6 inches with the power tool in a fully assembled state.

### CROSS-REFERENCE TO RELATED APPLICATIONS

This application is a non-provisional application claiming the benefit of priority under 35 U.S.C. § 119 (e) to U.S. Provisional Application No. 63/461,723, filed on Apr. 25, 2023, and U.S. Provisional Application No. 63/609,631, filed Dec. 13, 2023, which are hereby incorporated by reference in their entirety.

### FIELD

The present disclosure relates generally to outdoor power tools, such as pole saws and telescoping pole saws.

### BACKGROUND

Tool storage on utility vehicles, such as tree service, landscape maintenance, and power utility vehicles, is a strategic operation. The tools need to be easily accessible and kept secure during transportation. The tool storage should also have a small footprint to fit the tools effectively and efficiently on the utility vehicles. Tools are commonly stored in tubes mounted on the utility vehicles. However, there are currently no telescoping pole saws that can fit within such tubes in a fully assembled state.

Accordingly, improvements which address the above-described issues are desired in the art. In particular, a telescoping pole saw that fits within a tube mounted on a utility vehicle in a fully assembled state would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a power tool is provided. The power tool includes a housing including an electric motor, a work element, and a drive shaft extending between the electric motor and the work element. The power tool is configured to fit within a cylinder having a diameter no greater than 6 inches with the power tool in a fully assembled state.

In accordance with another embodiment, a power tool is provided. The power tool includes a housing including an electric motor, a work element, a drive shaft extending along a longitudinal axis between the electric motor and the work element, and at least one pole extending along the longitudinal axis between a first end and a second end. The drive shaft is disposed within the at least one pole. The power tool fits within a cylinder having a diameter no greater than 6 inches with the power tool in a fully assembled state. A motor axis extending through the electric motor is offset from the longitudinal axis.

In accordance with another embodiment, a method of using a power tool is provided. The method includes providing a pole tool in a container; with the pole tool disposed in the container, grasping the pole tool at a guard disposed on the housing of the pole tool; and translating, via the guard, the pole tool from a cylindrical storage volume of the container in a direction parallel with a longitudinal axis of the container. The pole tool includes a housing including an electric motor, a work element, and a drive shaft extending between the electric motor and the work element. The cylindrical storage volume has a diameter no greater than six inches and the pole tool is in a fully assembled state within the cylindrical storage volume.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a pole saw in accordance with embodiments of the present disclosure;

FIG. 2A is an interior view of a portion of the pole saw of FIG. 1 in accordance with embodiments of the present disclosure;

FIG. 2B is a cross-section of a portion of the pole saw of FIG. 1 in accordance with embodiments of the present disclosure;

FIG. 3A is a perspective, end view of the pole saw of FIG. 1 within a cylindrical container in accordance with embodiments of the present disclosure;

FIG. 3B is a perspective, end view of the pole saw of FIG. 1 within a cylindrical container in accordance with embodiments of the present disclosure;

FIG. 3C is a side view of the pole saw of FIG. 1 within a cylindrical container in accordance with embodiments of the present disclosure;

FIG. 4 is a side view of a utility vehicle including a cylindrical container in accordance with embodiments of the present disclosure; and

FIG. 5 is a flow chart of a method of operating the pole saw of FIG. 1 in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including.” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary. “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, tools are stored on utility vehicles within tubes, such as polyvinyl chloride (“PVC”) tubes, mounted to the utility vehicle. A telescoping pole saw may be stored within a tube in a fully assembled state such that it may be easily inserted into and removed from the tube. For example, the telescoping pole saw may fit within a tube having a diameter of 6 inches or less in its fully assembled state.

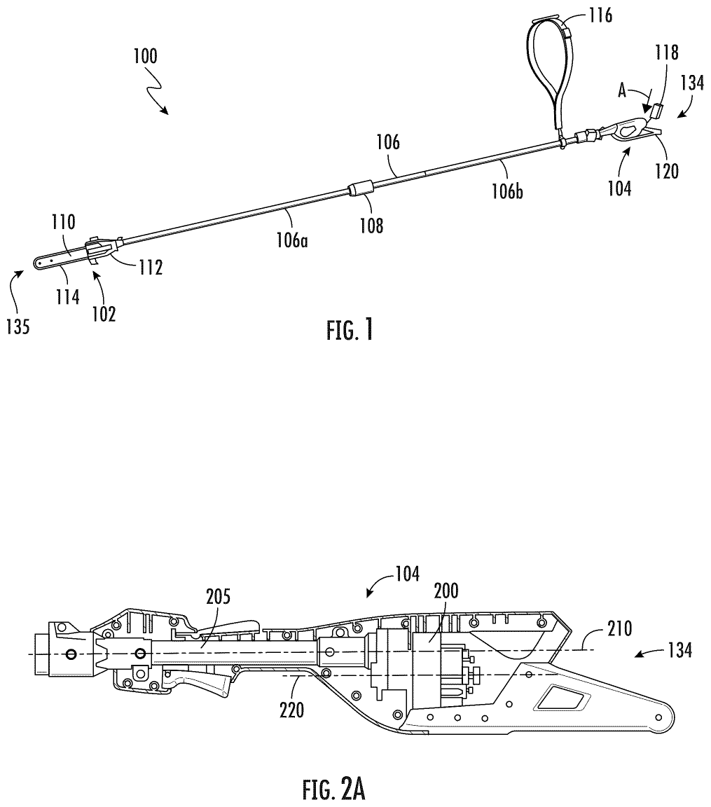

Referring now to the drawings, FIG. 1 illustrates a perspective view of a pole saw in accordance with embodiments of the present disclosure.

In at least one example embodiment, a pole saw 100 generally includes a work element 102, a housing 104, and a pole 106 extending between and connecting together the work element 102 and the housing 104. The housing 104 may be at a first end, such as a rear end 134, of the pole saw 100 and the work element 102 may be at a second end, such as a front end 135, opposite the first end of the pole saw 100.

In at least one example embodiment, the pole 106 is adjustable in length. For example, the pole 106 may be telescopic, including one or more segments 106A and 106B that telescopically move relative to one another. For example, the segment 106A may be an outer pole and the segment 106B may comprise an inner pole. In other example embodiments, the segment 106B may be the outer pole and segment 106A may be the inner pole. The inner pole may be configured to slide longitudinally within the outer pole between a retracted position and an extended position. An operator may adjust a distance between the work clement 102 and the housing 104 by adjusting the relative positions of the segments 106A and 106B with respect to one another. For example, the operator may move the one or more segments 106A and 106B between the retracted position and the extended position. In at least one example embodiment, a lock or a clamp 108 may be used to maintain the segments 106A and 106B at relatively fixed positions with respect to one another.

In at least one example embodiment, the work element 102 of the pole saw 100 is a sawing tool configured to cut material. The sawing tool includes a bar 110 extending from a work element housing 112. A chain 114 extends in an infinite loop around the bar 110 and is driven to move along a track of the bar 110. While holding the pole saw 100 at the housing 104 and the pole 106, an operator can maneuver the sawing tool into position nearby an object, such as a branch, and urge the chain 114 into the object with the chain 114 in motion to cut the object. The operator can repeat this process as necessary. An optional shoulder or body strap 116 may be coupled to at least a portion of the pole saw 100. For example, the optional shoulder or body strap 116 may be coupled to a portion of the pole 106 adjacent the housing 104. The optional shoulder or body strap 116 may be used for prolonged use of the pole saw 100 to mitigate fatigue.

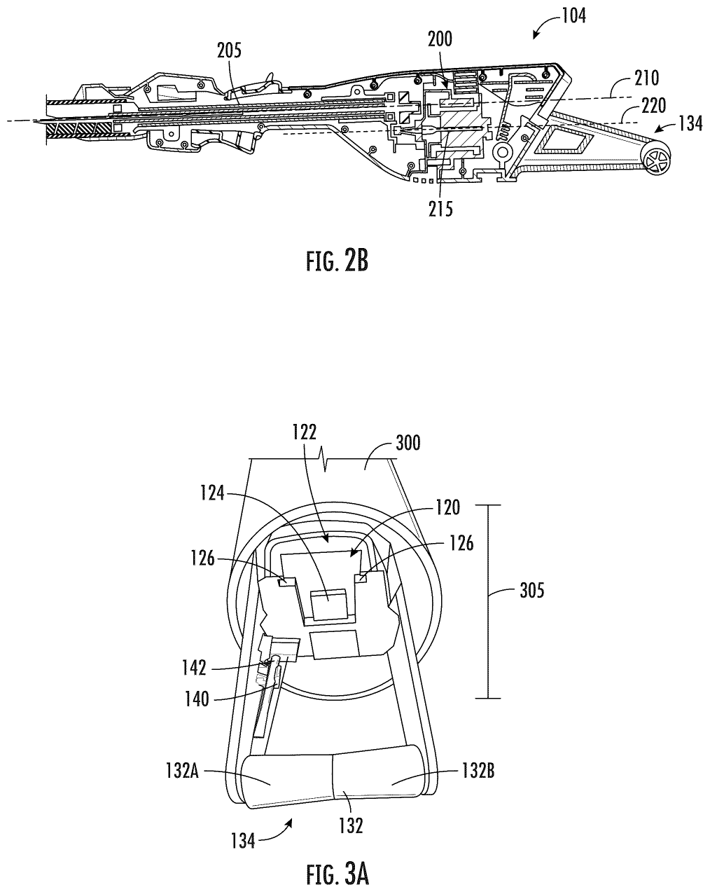

In at least one example embodiment, the chain 114 is driven by a motor. For example, the motor may be housed within the housing 104, as will be described with respect to FIGS. 2A-2B. A driveshaft can extend through the pole 106 to transfer power from the motor to the chain 114 through a chain sprocket. In other example embodiments, the motor may be housed within the work element housing 112 and drive the chain 114 through a chain sprocket.

In at least one example embodiment, the motor may be an electric motor, such as a direct current (DC) brushless motor. The motor includes an output shaft rotatably pinned to the chain sprocket, e.g., through a driveshaft. As the output shaft rotates, the chain 114 is driven within the track of the bar 110. In an example embodiment, the motor receives electrical power from a power source 118. For example, the power source 118 may include one or more batteries.

In at least one example embodiment, the pole saw 100 includes a receiving area 120 configured to receive the power source 118. For example, the receiving area 120 may be configured to receive one or more batteries, such as at least two batteries, at least three batteries, or even at least four batteries. In at least one example embodiment, the power source 118 may be installed in the receiving area 120 through a translational motion oriented in a direction shown by arrow A. In other example embodiments, the power source 118 may be installed in the receiving area 120 through a translational motion oriented in another direction, in a rotational motion, or in a translational-rotational motion.

FIG. 2A illustrates an interior view of a portion of the pole saw of FIG. 1 in accordance with embodiments of the present disclosure. FIG. 2B is a cross-section of a portion of the pole saw of FIG. 1 in accordance with embodiments of the present disclosure.

In at least one example embodiment, a motor 200 is disposed within the housing 104. The motor 200 may be an electric motor, as set forth above. A drive shaft 205 extends between the motor 200 and the work element 102. The drive shaft 205 extends along a longitudinal axis 210 extending from the rear end 134 to the front end 135 and along the pole 106 of the pole saw 100. For example, the drive shaft 205 is disposed within the pole 106 between the motor 200 and the work element 102.

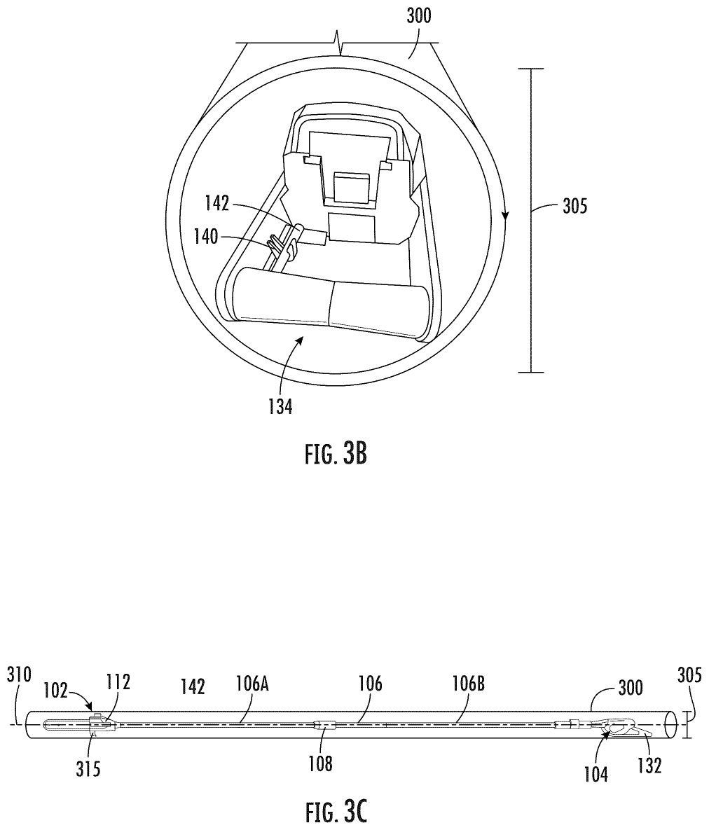

In at least one example embodiment, the motor 200 includes a motor shaft 215 configured to drive rotation of the drive shaft 205. The motor shaft 215 of the motor 200 may be offset from the drive shaft 205. For example, a motor axis 220 extending along the motor shaft 215 may be offset from the longitudinal axis 210. In at least one example embodiment, the motor axis 220 is parallel to the longitudinal axis 210. Offsetting the motor shaft 215 from the longitudinal axis 210 allows the housing 104 to have a smaller profile. For example, pole saw 100 may be configured to fit within a cylindrical container or tube, as will be discussed in greater detail with respect to FIGS. 3A-3C, below.

FIG. 3A illustrates a perspective, end view of the pole saw of FIG. 1 within a cylindrical container in accordance with embodiments of the present disclosure. FIG. 3B illustrates a perspective, end view of the pole saw of FIG. 1 within a cylindrical container in accordance with embodiments of the present disclosure. FIG. 3C illustrates a side view of the pole saw of FIG. 1 within a cylindrical container in accordance with embodiments of the present disclosure.

In at least one example embodiment, the pole saw 100 is configured to fit within a container 300 having a diameter 305 when in a fully assembled state. For example, the housing 104, the pole 106, and the work element housing 112 fit within the container 300 in the fully assembled state. The power source 118 may also fit within the container 300 in the fully assembled state. In at least one example embodiment, the diameter 305 of the container 300 is no greater than about 6 inches.

In at least one example embodiment, the container 300 is a cylinder, as shown in FIGS. 3A-3C. In other example embodiments, the container 300 may have a rectangular or other polygonal shape.

In at least one example embodiment, a central axis 310 extends through the container 300, as shown in FIG. 3C. The longitudinal axis 210 of the pole saw 100 may be configured to be parallel with the central axis 310 of the container 300 when the pole saw 100 is fully inserted into the container 300. For example, the pole saw may include a support 315 extending from the work element housing 112. At least a portion of the support 315 and the guard 132 may be configured to maintain the pole saw 100 in a level position such that the longitudinal axis 210 is parallel with the central axis 310 when the pole saw is within the container 300 in the fully assembled state. In other example embodiments, the longitudinal axis 210 of the pole saw 100 may be at an angle or offset from the central axis 310 of the container 300.

With reference to FIG. 3A, a shape and a size of the receiving area 120 of the pole saw 100 is generally defined by the shape and size of the power source 118, such as one or more batteries, received in the receiving area 120. It should be understood that the entire receiving area 120 may not be physically demarcated by the pole saw 100. Instead, the receiving area 120 can refer to a volumetric region of the pole saw 100 in which the power source 118 is disposed when coupled to the pole saw 100. In some example embodiments, the receiving area 120 can further include a volume through which the power source 118 passes when installed on the pole saw 100. The housing 104 (and optionally other components of the pole saw 100) may be shaped and sized such that the receiving area 120 is a close fit in size and shape to the power source 118 installed in the receiving area 120. Pole saws 100 receiving differently shaped and sized power sources 118 may define differently shaped and sized receiving areas 120.

In at least one example embodiment, the receiving area 120 may be disposed adjacent a terminal 122 of the pole saw 100. The terminal 122 is configured to interface with the power source 118 and provide power from the power source 118 to an electrical power system of the pole saw 100 that drives the motor 200. The terminal 122 can include electrical contacts 124 that mate with corresponding electrical contacts of the power source 118 to complete an electrical circuit between the power source 118 and the electrical power system of the pole saw 100. The terminal 122 can further include an engagement structure 126 configured to mechanically couple the power source 118 to the pole saw 100. The power source 118 can translate into the receiving area 120 from a first position until the power source 118 is electrically coupled to the terminal 122 in a second position within the receiving area 120.

In at least one example embodiment, the pole saw 100 includes a protective feature that extends around at least a portion of the receiving area 120 to protect the power source 118 from damage such as caused by impact with an object during use or a drop from the in-use position. The protective feature can include a guard 132. The guard 132 can be coupled to the housing 104 and extend from a rear end 134 of the housing 104 in a rearward direction. The guard 132 may also serve as a handle at the rear end 134 of the pole saw for grasping by an operator. In at least one example embodiment, the guard 132 can define a rearmost end of the pole saw 100. In another example embodiment, the guard 132 can be formed from two discrete components, such as a first component 132A and a second component 132B, coupled together. For example, the first component 132A and the second component 132B can each extend from the housing 104 and meet at a midline of the pole saw 100. The first component 132A and the second component 132B can each be coupled to the housing 104 and be coupled together by a fastener (not illustrated). In some example embodiments, the first component 132A and the second component 132B can be reflectively symmetrical about the midline of the pole saw 100, or substantially reflectively symmetrical about the midline of the pole saw 100.

In at least one example embodiment, the pole saw 100 includes a scrench holder 140 configured to receive a scrench 142. The scrench holder 140 and the scrench 142 may be disposed in the receiving area 120 of the pole saw 100. For example, an interior portion of the guard 132 may include the scrench holder 140, as shown in FIG. 3A. The first component 132A, the second component 132B, or both the first component 132A and the second component 132B may include the scrench holder 140 for selectively engaging the scrench 142. In at least one example embodiment, the entire scrench 142 can be disposed in the area defined by the receiving area 120 and the guard 132 when the scrench 142 is coupled with the scrench holder 140.

In at least one example embodiment, the scrench 142 is removable when the power source 118 is detached from the receiving area 120 of the housing 104 and removing the scrench 142 from the scrench holder 140 is prohibited when the power source 118 is disposed in the receiving area 120. With the power source 118 in the receiving area 120, any rotation of the scrench 142 is met by contact of the scrench 142 with an outer perimeter surface of the power source 118. Without rotation of the scrench 142, removal of the scrench 142 from the scrench holder 140 is not possible. Removing the scrench 142 from the scrench holder 140 thus requires removing the power source 118 from the receiving area 120 prior to removing the scrench 142. In other example embodiments, the step associated with removal of the scrench 142 prohibiting accidental detachment of the scrench 142 from the scrench holder 140 can be translational rather than rotational. In still other example embodiments, the step preventing accidental detachment of the scrench 142 can include both translational and rotational movement. For example, the scrench 142 may not be translatable or rotatable due to the relative placement of the power source 118, or another object of the pole saw 100, when installed in the receiving area 120.

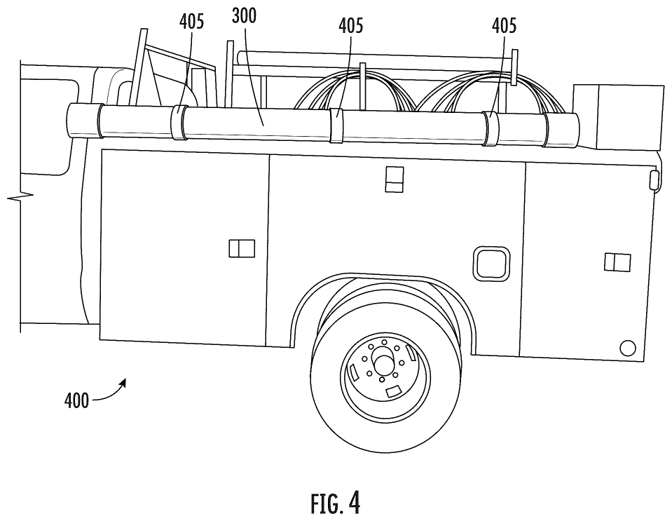

FIG. 4 illustrates a side view of a utility vehicle including a cylindrical container in accordance with embodiments of the present disclosure.

In at least one example embodiment, the container 300 may be mounted on a vehicle 400. The vehicle 400 may include a utility vehicle, such as utility vehicles used for tree services, landscape maintenance services, and power utility services. In at least one example embodiment, the container 300 includes a tube, such as a PVC tube, mounted on the vehicle 400.

In at least one example embodiment, one or more bindings 405 are configured to secure the container 300 to the vehicle 400. For example, the one or more bindings 405 may surround at least a portion of the container 300 and be secured to the vehicle 400 by one or more fasteners. The one or more fasteners may include bolts, screws, or other means for securing the container 300 to the vehicle via the one or more bindings 405. In at least one example embodiment, the one or more bindings 405 may be evenly spaced along a length of the container 300. In other example embodiments, the one or more bindings 405 are unevenly spaced along the length of the container 300.

In at least one example embodiment, the container 300 is mounted to one or more sides of the vehicle 400. For example, the container 300 may extend parallel to a length of the vehicle, as shown in FIG. 4. In at least one example embodiment, two or more of the containers 300 may be mounted on the vehicle 400 for receiving one or more of the pole saws 100 or other power tools.

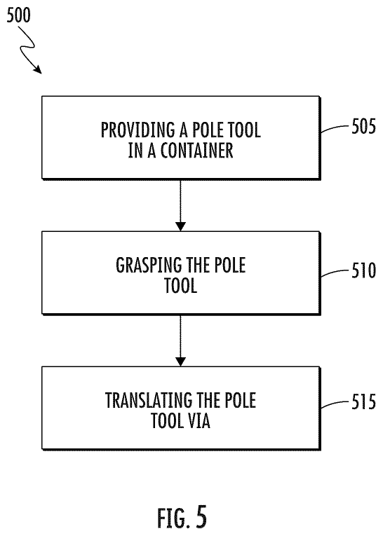

FIG. 5 is a flow chart of a method of operating the pole saw of FIG. 1 in accordance with embodiments of the present disclosure.

In at least one example embodiment, a method 500 of operating a power tool, such as the pole saw 100, includes providing a pole tool in a container at 505, grasping the pole tool at 510, and translating the pole tool at 515.

In at least one example embodiment, providing a pole tool in a container at 505 includes providing the pole saw 100 in the container 300, as shown in FIGS. 3A-3C. The pole saw 100 includes the housing 104 including the motor 200, the work element 102, and the pole 106. The pole saw 100 also includes the drive shaft 205 extending between the motor 200 and the work element 102. Additionally, the pole saw 100 includes the power source 118 within the receiving area 120 of the housing 104.

In at least one example embodiment, grasping the pole tool at 510 includes grasping the rear end 134 of the pole saw 100 while the pole saw 100 is disposed in the container 300. For example, the guard 132, including the first component 132A and the second component 132B, may be grasped by the operator. The pole saw 100 may be fully disposed within the container 300, as shown in FIGS. 3B-3C, when the guard 132 is grasped by the operator.

In at least one example embodiment, translating the pole tool at 515 includes translating the pole saw 100 from a cylindrical storage volume defined by the container 300. For example, the pole saw 100 may be translated from the cylindrical storage volume defined by the container 300 via the guard 132. The pole saw 100 may be translated in a direction that is parallel with the central axis 310 of the container 300. In at least one example embodiment, the pole saw 100 may be translated in a first direction such that the pole saw 100 is moved from the fully inserted position shown in FIGS. 3B-3C to the partially removed position shown in FIG. 3A and removed from the container 300. In at least one example embodiment, the cylindrical storage volume of the container 300 may have a diameter no greater than about 6 inches. Additionally, the pole saw 100 may fit within the cylindrical storage volume in a fully assembled state.

In at least one example embodiment, the method 500 further includes replacing the pole saw 100 within the container 300. The pole saw may be translated into the cylindrical storage volume of the container 300 in a direction parallel with the central axis 310 of the container 300. For example, the pole saw 100 may be inserted into the container 300 and translated in a second direction opposite the first direction such that the pole saw 100 moves from the partially inserted position shown in FIG. 3A to the fully inserted position shown in FIGS. 3B-3C. The pole saw 100 may be translated in the second direction via the guard 132.

Further aspects of the invention are provided by one or more of the following embodiments:

A power tool includes a housing including an electric motor, a work element, and a drive shaft extending between the electric motor and the work element. The power tool is configured to fit within a cylinder having a diameter no greater than 6 inches with the power tool in a fully assembled state.

The power tool of any one or more of the embodiments, wherein a motor axis extending through a center of the electric motor is offset from a longitudinal axis extending along the drive shaft.

The power tool of any one or more of the embodiments, wherein the motor axis is parallel to the longitudinal axis.

The power tool of any one or more of the embodiments, wherein the longitudinal axis is configured to be parallel with a central axis extending though the cylinder.

The power tool of any one or more of the embodiments includes a power source configured to supply power to the electric motor to drive the work element. The power source fits within the cylinder.

The power tool of any one or more of the embodiments, wherein the power source is removably coupled to a receiving area of the housing.

The power tool of any one or more of the embodiments includes a scrench disposed in the receiving area. The scrench is inaccessible when the power source is coupled to the housing and the scrench is removable when the power source is detached from the housing.

The power tool of any one or more of the embodiments, wherein the work element includes a work element housing, a bar extending from the work element housing, and a chain disposed around the bar. The chain is configured to be rotatably driven about the bar by the electric motor via the drive shaft. The work element housing, the bar, and the chain fit within the cylinder.

The power tool of any one or more of the embodiments includes a chain sprocket disposed in the work element housing. The chain is coupled to the chain sprocket. The chain sprocket is driven by the electric motor via the drive shaft to rotate the chain.

A power tool includes a housing including an electric motor, a work element, a drive shaft extending along a longitudinal axis between the electric motor and the work element, and at least one pole extending along the longitudinal axis between a first end and a second end. The drive shaft is disposed within the at least one pole. The power tool fits within a cylinder having a diameter no greater than 6 inches with the power tool in a fully assembled state. A motor axis extending through the electric motor is offset from the longitudinal axis.

The power tool of any one or more of the embodiments, wherein the motor axis is parallel to the longitudinal axis.

The power tool of any one or more of the embodiments, wherein the longitudinal axis is configured to be parallel with a central axis extending though the cylinder.

The power tool of any one or more of the embodiments, wherein the at least one pole is configured to move between a retracted position and extended position.

The power tool of any one or more of the embodiments, wherein the at least one pole includes an outer pole disposed at one of the first or second ends and an inner pole disposed at the other of the first or second ends. The inner pole is configured to slide longitudinally within the outer pole between a retracted position and an extended position.

The power tool of any one or more of the embodiments includes a clamp configured to secure the outer pole and the inner pole in a fixed position.

The power tool of any one or more of the embodiments includes a power source removably coupled to a receiving area of the housing. The power source fits within the cylinder.

The power tool of any one or more of the embodiments includes a scrench disposed in the receiving area. The scrench is inaccessible when the power source is coupled to the housing and the scrench is removable when the power source is detached from the housing.

A method of using a power tool includes providing a pole tool in a container; with the pole tool disposed in the container, grasping the pole tool at a guard disposed on the housing of the pole tool; and translating, via the guard, the pole tool from a cylindrical storage volume of the container in a direction parallel with a longitudinal axis of the container. The pole tool includes a housing including an electric motor, a work element, and a drive shaft extending between the electric motor and the work element. The cylindrical storage volume has a diameter no greater than six inches. The pole tool is in a fully assembled state within the cylindrical storage volume.

The method of any one or more of the embodiments, wherein a longitudinal axis extending though the drive shaft is configured to be parallel with the longitudinal axis of the container.

The method of any one or more of the embodiments includes replacing the pole tool within the container. The replacing comprises translating, via the guard, the pole tool into the cylindrical storage volume of the container in the direction parallel with the longitudinal axis of the container.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power tool, comprising:
a housing including an electric motor;
a work element; and
a drive shaft extending between the electric motor and the work element;
wherein the power tool is configured to fit within a cylinder having a diameter no greater than 6 inches with the power tool in a fully assembled state.

2. The power tool of claim 1, wherein a motor axis extending through a center of the electric motor is offset from a longitudinal axis extending along the drive shaft.

3. The power tool of claim 2, wherein the motor axis is parallel to the longitudinal axis.

4. The power tool of claim 2, wherein the longitudinal axis is configured to be parallel with a central axis extending though the cylinder.

5. The power tool of claim 1, further comprising a power source configured to supply power to the electric motor to drive the work element, wherein the power source fits within the cylinder.

6. The power tool of claim 5, wherein the power source is removably coupled to a receiving area of the housing.

7. The power tool of claim 6, further comprising:
a scrench disposed in the receiving area;
wherein the scrench is inaccessible when the power source is coupled to the housing; and
wherein the scrench is removable when the power source is detached from the housing.

8. The power tool of claim 1, wherein the work element comprises:
a work element housing;
a bar extending from the work element housing; and
a chain disposed around the bar;
wherein the chain is configured to be rotatably driven about the bar by the electric motor via the drive shaft; and
wherein the work element housing, the bar, and the chain fit within the cylinder.

9. The power tool of claim 8, further comprising:
a chain sprocket disposed in the work element housing;
wherein the chain is coupled to the chain sprocket; and
wherein the chain sprocket is driven by the electric motor via the drive shaft to rotate the chain.

10. A power tool, comprising:
a housing including an electric motor;
a work element;
a drive shaft extending along a longitudinal axis between the electric motor and the work element; and
at least one pole extending along the longitudinal axis between a first end and a second end, the drive shaft disposed within the at least one pole;
wherein the power tool fits within a cylinder having a diameter no greater than 6 inches with the power tool in a fully assembled state; and
wherein a motor axis extending through the electric motor is offset from the longitudinal axis.

11. The power tool of claim 10, wherein the motor axis is parallel to the longitudinal axis.

12. The power tool of claim 10, wherein the longitudinal axis is configured to be parallel with a central axis extending though the cylinder.

13. The power tool of claim 10, wherein the at least one pole is configured to move between a retracted position and extended position.

14. The power tool of claim 10, wherein the at least one pole comprises:
an outer pole disposed at one of the first or second ends; and
an inner pole disposed at the other of the first or second ends;
wherein the inner pole is configured to slide longitudinally within the outer pole between a retracted position and an extended position.

15. The power tool of claim 14, further comprising a clamp configured to secure the outer pole and the inner pole in a fixed position.

16. The power tool of claim 10, further comprising a power source removably coupled to a receiving area of the housing, wherein the power source fits within the cylinder.

17. The power tool of claim 16, further comprising:
a scrench disposed in the receiving area:
wherein the scrench is inaccessible when the power source is coupled to the housing; and
wherein the scrench is removable when the power source is detached from the housing.

18. A method of using a power tool, comprising:
providing a pole tool in a container, the pole tool comprising:
a housing including an electric motor,
a work element, and
a drive shaft extending between the electric motor and the work element;
with the pole tool disposed in the container, grasping the pole tool at a guard disposed on the housing of the pole tool; and
translating, via the guard, the pole tool from a cylindrical storage volume of the container in a direction parallel with a longitudinal axis of the container,
wherein the cylindrical storage volume has a diameter no greater than six inches, and wherein the pole tool is in a fully assembled state within the cylindrical storage volume.

19. The method of claim 18, wherein a longitudinal axis extending though the drive shaft is configured to be parallel with the longitudinal axis of the container.

20. The method of claim 18, further comprising:
replacing the pole tool within the container;
wherein the replacing comprises translating, via the guard, the pole tool into the cylindrical storage volume of the container in the direction parallel with the longitudinal axis of the container.
